(19) United States
(12) Patent Application Publication
(10) Pub. No.: US 2011/0150147 A1
(43) Pub. Date: Jun. 23, 2011

(54) DEVICE, SYSTEM AND METHOD OF MULTIPLE-INPUT-MULTIPLE-OUTPUT WIRELESS COMMUNICATION

(76) Inventors: Xuebin Yang, Beijing (CN); Senjie Zhang, Beijing (CN); Tzahi Weisman, Mevaseret Zion (IL)

(21) Appl. No.: 12/645,526

(22) Filed: Dec. 23, 2009

(51) Int. Cl. H04L 27/06

(52) U.S. Cl. 375/341; 375/340

(57) ABSTRACT

Some demonstrative embodiments include devices, systems and/or methods of multiple-input-multiple-output (MIMO) wireless communication. For example, a device may include a MIMO decoder to decode a MIMO transmission encoded over a constellation scheme including a first number of constellation points; wherein, the decoder is to determine at least one initial constellation point corresponding to at least one received value of the MIMO transmission, and to select a set of selected constellation points including the initial constellation point, wherein the selected set of constellation points includes a second number, lesser than the first number, of the constellation points, and wherein, for each bit-location of the initial constellation point, the selected set of constellation points includes at least one constellation point having, at the bit location, a bit value opposite to the bit value of the initial constellation point at the bit location; and wherein the decoder is to decode the MIMO transmission using the set of selected constellation points. Other embodiments are described and claimed.

### BACKGROUND

A wireless communication system may include a first station able to communicate with a second station over a communication channel. In a spatial multiplexing communication system the first station may include at least one transmitter to transmit parallel streams representing a message over a plurality of N_{TX}>1 streams, e.g., via a plurality of transmit antennas. The second station may include a receiver to receive a plurality of symbols corresponding to the transmitted streams via a plurality of receive antennas (N_{RX}≧N_{TX}). For example, according to a Single-User Multiple-Input-Multiple-Input (SU-MIMO) scheme, the first station may include a single transmitter to transmit the N_{TX} streams. According to a Multi-User Multiple-Input-Multiple-Input (MU-MIMO) scheme, the first station may include a plurality of transmitters, each to transmit one or more of the N_{TX} streams. For simplicity, the N_{TX} streams may be referred to as N_{TX} transmit antennas.

The receiver may include a decoder to decode the received symbols, which may be a mixture of the transmitted symbols, into metrics (LLRs); and to determine an estimation of the message based on the metrics based on a suitable decoding technique, for example, a Maximum Likelihood Sequence Estimation (MLSE) decoding technique.

The decoder may determine the metrics based on a Maximum Likelihood Decoding (MLD) algorithm, which may include scanning all constellation points of all the N_{TX} transmit antennas. Accordingly, the MLD algorithm may have a complexity of an order of Q^{N}^{_{TX}}, wherein Q denotes a constellation size of a constellation scheme implemented by the transmitter, i.e., the number of constellation points in the constellation scheme. For example, if N_{TX}=2, and Q=64, then the MLD algorithm may have a complexity of an order of 4096, which may be relatively high and/or may not be efficient for implementation.

Some “sub-optimum” decoding algorithms, for example, sphere decoding, lattice reduction and/or gradient-based MLD, may reduce the complexity of the decoding, but may provide poor and/or inaccurate results.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of three sets of initial constellation points, in accordance with some demonstrative embodiments.

FIG. 3 is a schematic illustration of schematically illustrates a constellation scheme including 64 constellation points.

FIG. 4 is a schematic illustration of a set of selected constellation points, in accordance with a demonstrative embodiment.

FIG. 5 is a schematic illustration of a set of selected constellation points, in accordance with another demonstrative embodiment.

FIG. 6 is a schematic illustration of a set of selected constellation points, in accordance with another demonstrative embodiment.

FIG. 7 is a schematic illustration of a set of selected constellation points, in accordance with another demonstrative embodiment.

FIG. 8 is a schematic illustration of a set of selected constellation points, in accordance with another demonstrative embodiment.

FIG. 9 is a schematic flow-chart illustration of a method of decoding a multiple-input-multiple-output transmission, in accordance with some demonstrative embodiments.

FIG. 10 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a wired or wireless network, a wireless area network, a Wireless Video Area Network (WVAN), a Local Area Network (LAN), a Wireless LAN (WLAN), a Wireless Metropolitan Area Network (WMAN) communication system, a Personal Area Network (PAN), a Wireless PAN (WPAN), devices and/or networks operating in accordance with existing IEEE 802.11 (IEEE 802.11-1999: Wireless LAN Medium Access Control (MAC) and Physical Layer (PHY) Specifications), 802.11a, 802.11b, 802.11g, 802.11h, 802.11j, 802.11n, 802.11 task group ad (TGad), 802.15.3c, 802.16 (IEEE-Std 802.16, 2004 Edition, Air Interface for Fixed Broadband Wireless Access Systems), 802.16d, 802.16e (IEEE-Std 802.16e, 2005 Edition, Physical and Medium Access Control Layers for Combined Fixed and Mobile Operation in Licensed Bands), 802.16f, 802.16m standards and/or future versions and/or derivatives thereof, devices and/or networks operating in accordance with existing Wireless-Gigabit-Alliance (WGA) and/or WirelessHD™ specifications and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

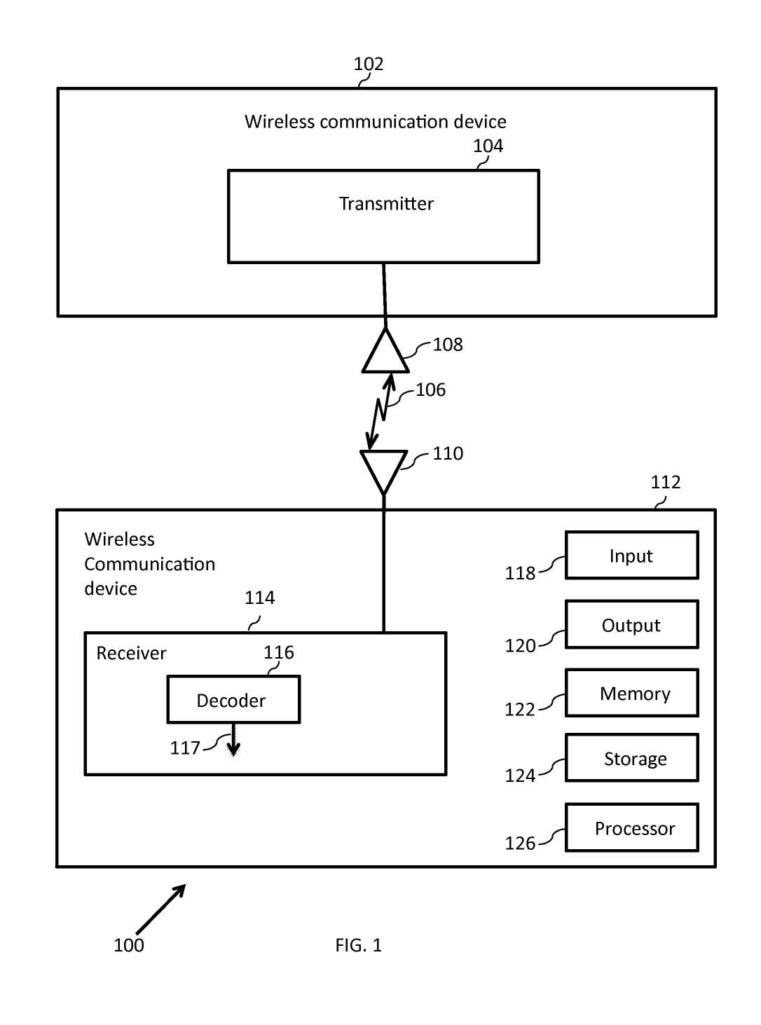

Reference is now made to FIG. 1, which schematically illustrates a block diagram of a system 100 in accordance with some demonstrative embodiments.

As shown in FIG. 1, in some demonstrative embodiments, system 100 may include a wireless communication network including one or more wireless communication devices, e.g., wireless communication devices 102 and/or 112, capable of communicating content, data, information and/or signals over at least one suitable wireless communication channel 106, for example, a radio channel, an IR channel, a RF channel, a Wireless Fidelity (WiFi) channel, and the like. One or more elements of system 100 may optionally be capable of communicating over any suitable wired communication links.

In some demonstrative embodiments, wireless communication devices 102 and/or 112 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, an AP, a base station, or the like.

In some demonstrative embodiments, device 102 may include N_{TX} antennas 108, and/or device 112 may include N_{RX} antennas 110 to transmit and/or receive symbols, e.g., over channel 106. Types of antennae that may be used for antennas 108 and/or 110 may include but are not limited to internal antenna, dipole antenna, omni-directional antenna, a monopole antenna, an end fed antenna, a circularly polarized antenna, a micro-strip antenna, a diversity antenna and the like.

In some demonstrative embodiments, communication device 102 may include a transmitter 104 to transmit a MIMO transmission to device 112 by transmitting a set of N_{TX} signals via N_{TX} antennas 108, respectively.

In some demonstrative embodiments, the MIMO transmission may be encoded over a suitable constellation scheme including a first number, denoted Q, of constellation points. For example, one or more of the transmitted signals may include one or more Orthogonal Frequency Division Multiple Access (OFDMA) symbols modulated over one or more subcarriers. For example, a signal of the transmitted signals may include a plurality of Quadrature Amplitude Modulation (QAM) symbols modulated over a plurality of subcarriers. The QAM symbols may include, for example, symbols selected from a constellation of the size Q (the “Q-ary constellation”), as is known in the art. For example, the QAM symbols may include 2-QAM symbols, Quadrature Phase Shift Key (QPSK) symbols, 8-QAM symbols, 16-QAM symbols, 64-QAM symbols, and/or any other suitable symbols.

Some demonstrative embodiments are described herein with reference to a constellation scheme, e.g., the 64QAM constellation scheme, including Q=64 constellation points. However, other embodiments may include any other suitable constellation scheme including any other suitable number of constellation points.

In some demonstrative embodiments, communication device 102 may use a subcarrier permutation for communicating with device 112. The permutation may include, for example, a predefined set of subcarriers, e.g., selected from a plurality of available subcarriers. Communication device 102 may use one or more other permutations for communicating with one or more other devices.

In some demonstrative embodiments, communication device 112 may include a receiver 114 to receive signals of the MIMO transmission over channel 106. For example, receiver 114 may receive a set of N_{RX} time-domain signals via N_{RX} antennas 110, respectively. The received signals may include symbols modulated over the subcarrier permutation of device 112. The N_{RX} received signals may include symbols corresponding, for example, to symbols of the signals of the MIMO transmission transmitted by transmitter 104.

In some demonstrative embodiments, wireless communication devices 102 and/or 112 may also include, for example, one or more of a processor 126, an input unit 118, an output unit 120, a memory unit 122, and a storage unit 124. Wireless communication devices 102 and/or 112 may optionally include other suitable hardware components and/or software components. In some demonstrative embodiments, some or all of the components of each of wireless communication devices 102 and/or 112 may be enclosed in a common housing or packaging, and may be interconnected or operably associated using one or more wired or wireless links. In other embodiments, components of each of wireless communication devices 102 and/or 112 may be distributed among multiple or separate devices.

Processor 126 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 126 executes instructions, for example, of an Operating System (OS) of wireless communication devices 102 and/or 112 and/or of one or more suitable applications.

Input unit 118 includes, for example, a keyboard, a keypad, a mouse, a touch-pad, a track-ball, a stylus, a microphone, or other suitable pointing device or input device. Output unit 120 includes, for example, a monitor, a screen, a flat panel display, a Cathode Ray Tube (CRT) display unit, a Liquid Crystal Display (LCD) display unit, a plasma display unit, one or more audio speakers or earphones, or other suitable output devices.

Memory unit 122 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 124 includes, for example, a hard disk drive, a floppy disk drive, a Compact Disk (CD) drive, a CD-ROM drive, a DVD drive, or other suitable removable or non-removable storage units. Memory unit 122 and/or storage unit 124, for example, may store data processed by wireless communication device 102 and/or 112.

In some demonstrative embodiments, receiver 114 may include any suitable elements and/or modules to process the time-domain signals received from antennas 110, for example, to generate a plurality of channel estimations of the plurality of subcarriers, respectively. For example, a channel corresponding to a subcarrier of the plurality of subcarriers may be represented by a channel matrix, denoted H, e.g., a N_{RX}×N_{TX} matrix, as is known in the art.

In some demonstrative embodiments, receiver 114 may be implemented, for example, using separate and/or integrated units, for example, using a transmitter-receiver, transceiver, wireless communication unit, Network Interface Card (NIC), and the like.

In some demonstrative embodiments, receiver 114 may include a MIMO decoder 116 to decode the received signals of the MIMO transmission and to generate signals 117 representing an estimation of the signals transmitted by device 102, e.g., as described in detail below.

In some demonstrative embodiments, decoder 116 may decode the MIMO transmission using a “sub-optimum” Maximum-Likelihood-Decoding (MLD) algorithm utilizing a combination of a linear MIMO decoding method, e.g., Zero Forcing (ZF) or Minimum Mean Square Error (MMSE), as well as hypotheses test and signal modulation character methods, e.g., as described below. According to these embodiments, decoder 116 may have a decoding performance, e.g., in terms of accuracy, which may be almost the same of the performance of a brute-force MLD method, while having a lower complexity, e.g., a complexity of an order of N_{TX} log 2(Q).

The set of signals received by receiver 114 over a subcarrier of the subcarrier permutation of device 112, may be represented, for example, as follows:

\vec{y}=H\vec{s}+\vec{n} (1)

wherein y denotes a [N_{RX}×1] vector representing the N_{RX} respective signals received over N_{Rx} antennas 110, respectively; s denotes a [N_{TX}×1] vector including N_{TX} symbols of a Q-ary constellation transmitted via N_{TX} antennas 108, respectively; and n denotes a [N_{RX}×1] vector representing noise, e.g., Gaussian noise.

A MLD solution, denoted \vec{s}_{MLD}, of Equation 1 may be represented by the following equation:

$${{s}^{->}}_{MLD} = {argmin}_{{s}^{->} ∈ {Q}^{{N}_{Tx}}} {‖ {y}^{->} - H {s}^{->} ‖}^{2} \qquad ( 2 )$$

A conventional MLD solution scheme may scan for all of the Q^{N}^{_{TX}} combinations of possible transmit signals and the complexity of solving Equation 2 may be Q^{N}^{_{TX}} for each channel realization decoding.

For linear equalization decoding, for example, ZF or MMSE, the solution for equation (1) may be represented as:

$${x}^{->} = {( {x}_{1} {x}_{2} … {x}_{N} )}^{T} = {H}^{+} {y}^{->} , {s}^{->} = slice ( {x}^{->} ) \\ {H}^{+} = \{ \begin{matrix}{( {H}^{H} H + {σ}^{2} I )}^{- 1} {H}^{H} & M M S E \\ {( {H}^{H} H )}^{- 1} {H}^{H} & Z F\end{matrix} \qquad ( 3 )$$

wherein x denotes an estimation of the transmitted value corresponding to the respective received value of y; wherein slice(\vec{x}) denotes a demodulation operation to determine a nearest constellation point of the Q constellation points, which is nearest to \vec{x}; wherein T denotes a transpose operation; wherein H^{H} denotes a conjugate transpose of the channel matrix; wherein I denotes an identity matrix; and wherein σ² denotes a power ratio of Gaussian noise to signal.

In some demonstrative embodiments, MIMO decoder 116 may select a plurality of sets of selected constellation points corresponding to a plurality of received values of at least one stream of the N_{TX} streams of the MIMO transmission. For example, MIMO decoder 116 may determine, e.g., for each received value of the stream, at least one initial constellation point and selecting a set, denoted St, of selected constellation points including the initial constellation point, wherein the selected set of constellation points includes a second number, denoted R, which is lesser than the number Q of the constellation points in the constellation scheme, e.g., as described below.

In some demonstrative embodiments, MIMO decoder 116 may select the constellation points of the set St, such that, for example, for each bit-location of the initial constellation point, the selected set of constellation points includes at least one constellation point having, at the bit location, a bit value opposite to the bit value of the initial constellation point at the bit location, e.g., as described below.

In some demonstrative embodiments, the number R of constellation points in the set St may be less than half, for example, less than a third, e.g., less than a quarter or even less than a fifth, of the number Q of constellation points in the constellation scheme, e.g., as described below.

In some demonstrative embodiments, MIMO decoder 116 may decode the received MIMO transmission using the plurality of sets of selected constellation points, for example, according to a suitable decoding scheme, e.g., as described below.

In some demonstrative embodiments, decoder 116 may decode the MIMO transmission by applying a MLD method to the selected constellation points corresponding to the values of the at least one stream, and to apply a linear decoding method to one or more other streams, e.g., as described below. In other embodiments, decoder 116 may decode the MIMO transmission based on the selected constellation points using any other suitable decoding method and/or algorithm.

In some demonstrative embodiments, decoder 106 may estimate the transmitted values x corresponding to the received values y, e.g., according to the linear solution of Equation 3.

In some demonstrative embodiments, decoder 160 may perform the operations described below for at least one stream of the N_{TX} transmitted streams of the MIMO transmission. In one embodiment, decoder 160 may perform the operations described below for N_{TX} times, wherein in each time, decoder 160 may perform the operations with respect to a different k-th stream, k=1 . . . N_{TX}, of the N_{TX} transmitted streams.

In some demonstrative embodiments, decoder 116 may determine at least one initial constellation point corresponding to the estimated value xₖ. In some embodiments, decoder 116 may determine at least two initial constellation points corresponding to the estimated value xₖ, e.g., as described below. In other embodiments, decoder 116 may determine any other suitable number of constellation points, e.g., a single initial constellation point or three or more initial constellation points, corresponding to the estimated value xₖ,

In some demonstrative embodiments, decoder 116 may determine first and second initial constellation points, denoted s₁ and s₂, respectively, for example, as follows, e.g., for a 64QAM constellation:

$${x}_{r , k} = real ( {x}_{k} ) , {x}_{i , k} = imag ( {x}_{k} ) \\ {s}_{1} = slice ( {x}_{k} ) = {s}_{r , 1} + {js}_{i , 1} , \\ {s}_{2} = \{ \begin{matrix}{s}_{1} + 2 Δ sign ( {x}_{k} - {s}_{1} ) & \vert {x}_{r , k} \vert < 7 and \vert {x}_{i , k} \vert < 7 \\ 5 sign ( {x}_{r , k} ) + j ( {s}_{i , 1} + 2 Δ sign ( {x}_{i , k} - {s}_{i , 1} ) ) & \vert {x}_{r , k} \vert >= 7 and \vert {x}_{i , k} \vert < 7 \\ {s}_{r , 1} + 2 Δ sign ( {x}_{r , k} - {s}_{r , 1} ) + j 5 sign ( {x}_{i , k} ) & \vert {x}_{r , k} \vert < 7 and \vert {x}_{i , k} \vert >= 7 \\ 5 sign ( {x}_{r , k} ) + j5sign ( {x}_{i , k} ) & \vert {x}_{r , k} \vert < 7 and \vert {x}_{i , k} \vert >= 7\end{matrix} \qquad ( 4 )$$

wherein real(x) denotes a real component of a complex representation of x, and wherein imag(x) denotes an imaginary component of the complex representation of x.

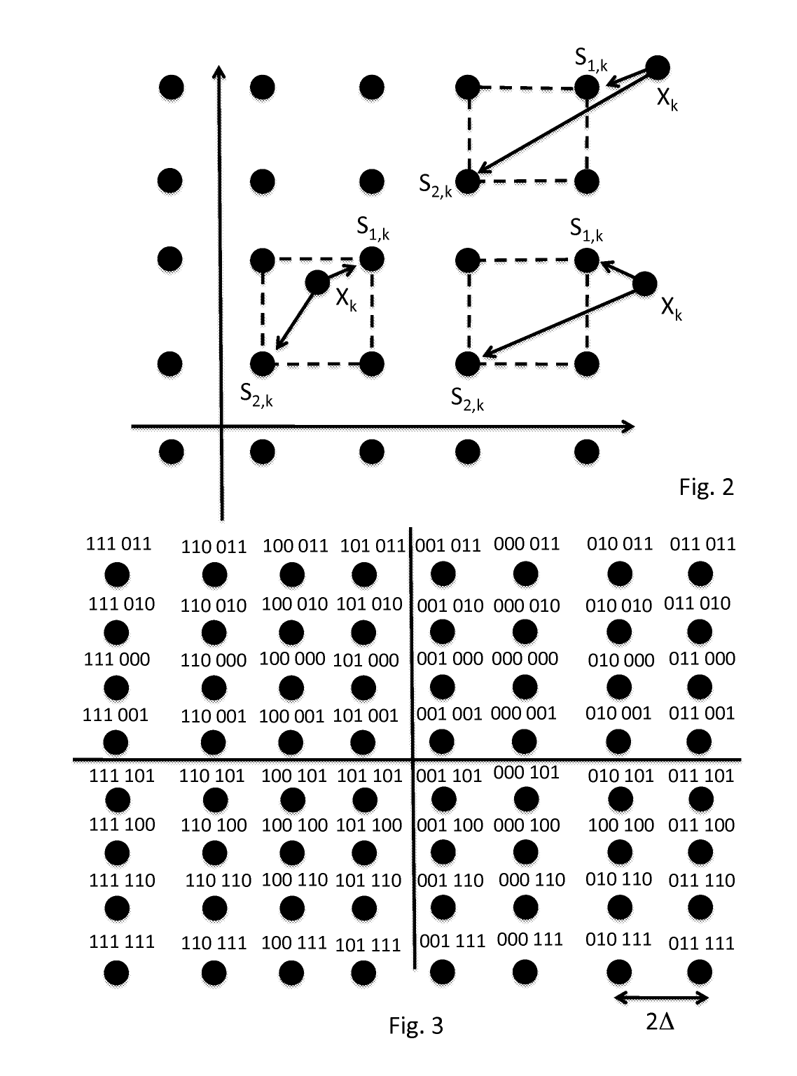

FIG. 2, schematically illustrates three sets of first and second initial constellation points defined with respect to three respective different values of x, e.g., according to Equation set 4. As shown in FIG. 2, initial constellation points s₁ may include a constellation point, which is closest to the value xₖ; and initial constellation point s₂ may include a constellation point which is located at a distance of one constellation point below constellation point s₁ and at a distance of one constellation point to the left of constellation point s₁.

In other embodiments, decoder 116 may determine the initial constellation points s₁ and/or s₂ based on any other suitable method and/or algorithm.

In some demonstrative embodiments, decoder 116 may select the set St of selected constellation points including the initial constellation points s₁ and/or s₂. Decoder 116 may select the set St such that, for example, for each initial constellation point of the constellation points, for each bit-location of the initial constellation point, the selected set St includes at least one constellation point having, at the bit location, a bit value opposite to the bit value of the initial constellation point at the bit location, e.g., as described below.

FIG. 3 schematically illustrates a 64QAM constellation scheme including 64 constellation points distributed over a constellation plane. The constellation points are defined by the intersections, over a Cartesian plane, between the eight vertical lines x=−7Δ/−5Δ/−3Δ/−Δ/Δ/3Δ/5Δ/7Δ and the eight horizontal lines y=−7Δ/−5Δ/−3Δ/−Δ/Δ/3Δ/5Δ/7Δ. As shown in FIG. 3, each of the real and imaginary components of each constellation point of the 64QAM constellation scheme may have a value of (−7), (−5), (−3), (−1), 1, 3, 5, or 7. Accordingly, each constellation point may be defined by a first 3-bit value representing a real component of the constellation point and a second 3-bit value representing an imaginary component of the constellation point. The possible values of each of the components of each constellation point of the constellation scheme may be represented by a vector, denoted GrayIdx. For example, for the 64QAM constellation of FIG. 3, GrayIdx=[−7 −5 −3 −1 1 3 5 7].

In some demonstrative embodiments, a matrix, denoted Grayneighbor, may be defined with respect to the values of the vector GrayIdx. The matrix Grayneighbor may include, for each value of the vector GrayIdx, one or more corresponding values. For example, for the 64QAM constellation of FIG. 3, the matrix Grayneighbor may include three values corresponding to each entry of the vector GrayIdx, e.g., as described below; while for a QPSK constellation scheme, the matrix Grayneighbor may include a single value corresponding to each entry of the vector GrayIdx; and for a 16QAM constellation scheme, the matrix Grayneighbor may include two values corresponding to each entry of the vector GrayIdx.

In some demonstrative embodiments, an i-th row of the matrix Grayneighbor may correspond to an i-th entry of the vector GrayIdx. A set Aᵢₘ={a_{i,m,1},a_{i,m,2}, . . . a_{i,m,K}} may be defined to include all entries in the vector GrayIdx, in which the m-th bit is different from the m-th bit of the i-th entry in the vector GrayIdx. For example, for the 64QAM constellation scheme of FIG. 3, K=4. The m-th entry of the i-th row of the matrix Grayneighbor may be defined to include the entry in the set Aᵢₘ, which meets requirement

$${min}_{k ∈ [ 1 , K ]} {\vert {a}_{i , m , k} - GrayIdx ( i ) \vert}^{2} .$$

In one example, the first element in the vector GrayIdx is the value (−7), which may be represented by the bits [111]. The first least-significant bit (LSB) of the value (−7) is 1 and accordingly, the set A₁₁={−5,−3,3,5} may be determined. Accordingly, Grayneighbor(1,1)=−5, e.g., since the value (−5) is the value of the set A₁₁, which is nearest to the value (−7). The second LSB of the value (−7) is 1 and accordingly, the set A₁₂={−3,−1,1,3} may be determined. Accordingly, Grayneighbor(1,2)=−3, e.g., since the value (−3) is the value of the set A₁₂, which is nearest to the value (−7). In a similar manner, the value Grayneighbor(1,2)=1 may be determined.

In some demonstrative embodiments, the following matrix Grayneighbor may be defined for the 64QAM constellation scheme:

Grayneighbor=[−5 −3 1; −7 −3 1; −1 −5 1; −3 −5 1; 3 5 −1; 1 5 −1; 7 3 −1; 5 3 −1] (5)

In some demonstrative embodiments, at least one matrix Grayneighbor may be determined corresponding to the values of the vector GrayIdx of the real component values of the constellation scheme as well as the values of the vector GrayIdx of the imaginary component values of the constellation scheme. In some embodiments, e.g., as described herein with reference to the 64QAM constellation scheme, the same matrix Grayneighbor may be used with respect to the real and imaginary component values of the constellation scheme, e.g., since both the real and imaginary components are represented by the same vector GrayIdx. In other embodiments, a plurality of matrices Grayneighbor may be defined, e.g., if the real and imaginary components are represented different vectors GrayIdx.

In some demonstrative embodiments, the matrix Grayneighbor may be predetermined, e.g., based on the constellation scheme implemented by system 100. In some embodiments, the predetermined matrix Grayneighbor may be stored by device 112, for example, in memory 122 and/or storage 124. The predetermined matrix Grayneighbor may be stored, for example, in the form of a look-up-table (LUT) or any other suitable form.

In some demonstrative embodiments, the set St of constellation points may be selected to include one or more of the values Grayneighbor(i,:), for example, all of the values Grayneighbor(i,:), e.g., all three values of Grayneighbor(i,:) in the 64QAM constellation, corresponding to the value of GrayIdx(i). According to these embodiments, the set St of constellation points may result in a relatively high LLR quality, for example, since a distance between the values of Grayneighbor(i,:) and GrayIdx(i) may be minimal.

In some demonstrative embodiments, the set St of selected constellation points may guarantee that at least one suitable LLR value may be determined corresponding to each bit representing each of the initial constellation points. For example, if GrayIdx(m) and Grayneighbor(m,:) are hypotheses tested, LLR for all 3 bits of m, e.g., in the case of 64QAM, may be generated.

In some embodiments, if LLR for W bits are needed, it is possible to test only at least W+1 states. Accordingly, the minimal number of states required for hypotheses testing may be N_{TX}*log 2(Q)+1. This number of states may be substantially lower than the number of states required from brute-force MLD decoding, e.g., at the order of Q^{N}^{_{TX}}.

Reference is now made to FIG. 4, which schematically illustrates a set 400 of selected constellation points, in accordance with a demonstrative embodiment. As shown in FIG. 4, the set St corresponding to the value xₖ may include the first and second initial constellation points s₁ and s₂ corresponding to the value xₖ, e.g., according to Equation set 4. As shown in FIG. 4, the set St may also include all constellation points on the same row 402 of the initial constellation point s₁, all constellation points on the same column 404 of the initial constellation point s₁, all constellation points on the same row 406 of the initial constellation point s₂, and all constellation points on the same column 408 of the initial constellation point s₂. For example, the set St may be defined as follows:

St={s_{r,1}+jGrayIdx(:),GrayIdx(:)+js_{i,1},s_{r,2}+jGrayIdx(:),GrayIdx(:)+js_{i,2}} (6)

As shown in FIG. 4, the set St may include R=28 different constellation points (or 32 constellation points if counted with repetition).

In some demonstrative embodiments, decoder 116 may select the set St such that for each bit-location of each initial constellation point, the set St includes a single constellation point at a shortest distance from the initial constellation point with respect to other constellation points having, at the bit location, a bit value opposite to the bit value of the initial constellation point at the bit location, e.g., as described below.

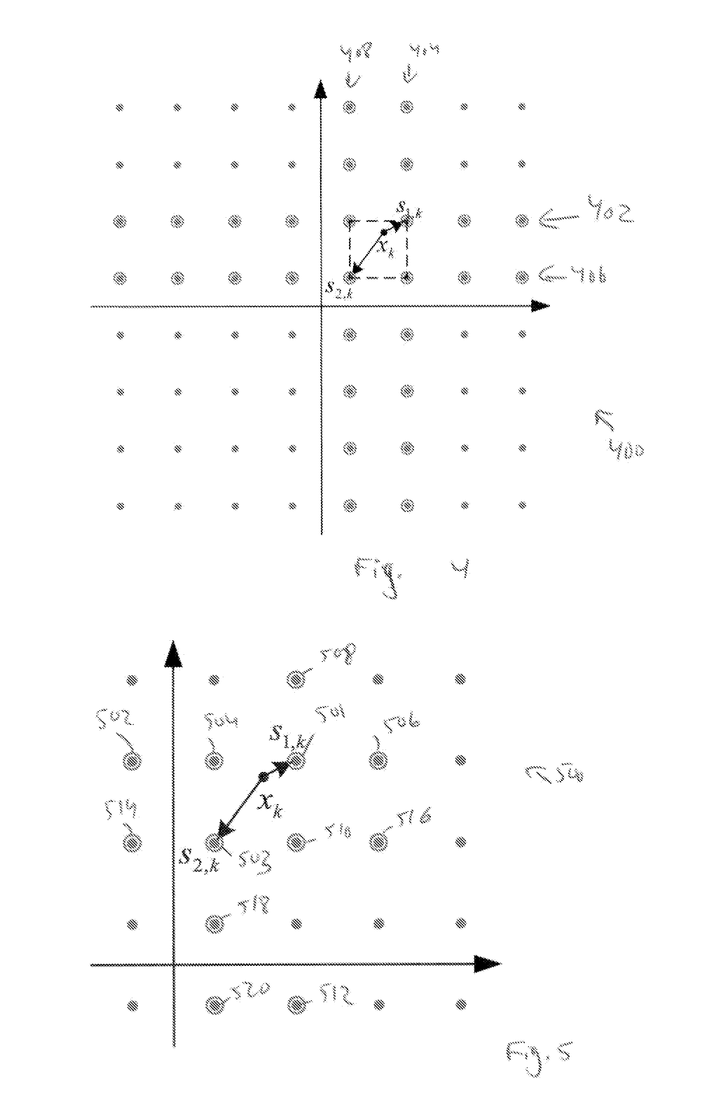

Reference is now made to FIG. 5, which schematically illustrates a set 500 of selected constellation points, in accordance with another demonstrative embodiment. As shown in FIG. 5, the set St corresponding to the value xₖ may include the first and second initial constellation points s₁ (501) and s₂ (503) corresponding to the value xₖ, e.g., according to Equation set 4. As shown in FIG. 5, the set St may also include the three constellation points 502, 504 and 506 on the same row of the initial constellation point s₁ having real component equal to a respective one of the three values of matrix Grayneighbor corresponding to the imaginary component of the initial constellation point s₁; the three constellation points 508, 510 and 512 on the same column of the initial constellation point s₁ having real component equal to a respective one of the three values of matrix Grayneighbor corresponding to the real component of the initial constellation point s₁; the three constellation points 510, 514 and 516 on the same row of the initial constellation point s₂ having real component equal to a respective one of the three values of matrix Grayneighbor corresponding to the imaginary component of the initial constellation point s₂; and the three constellation points 504, 518 and 520 on the same column of the initial constellation point s₂ having real component equal to a respective one of the three values of matrix Grayneighbor corresponding to the real component of the initial constellation point s₂. For example, the set St may be defined as follows:

$$St = \{ \begin{matrix}{s}_{1} , {s}_{r , 1} + j GrayNeighbor ( ( {s}_{i , 1} / Δ + 7 ) / 2 + 1 , \text{:} ) , \\ GrayNeighbor ( ( {s}_{r , 1} / Δ + 7 ) / 2 + 1 , \text{:} ) + j {s}_{i , 1} , \\ {s}_{2} , {s}_{r , 2} + j GrayNeighbor ( ( {s}_{i , 2} / Δ + 7 ) / 2 + 1 , \text{:} ) , \\ GranNeighbor ( ( {s}_{r , 2} / Δ + 7 ) / 2 + 1 , \text{:} ) + j {s}_{i , 2}\end{matrix} \} \qquad ( 7 )$$

As shown in FIG. 5, the set St may include R=12=2 log 2(Q) different constellation points.

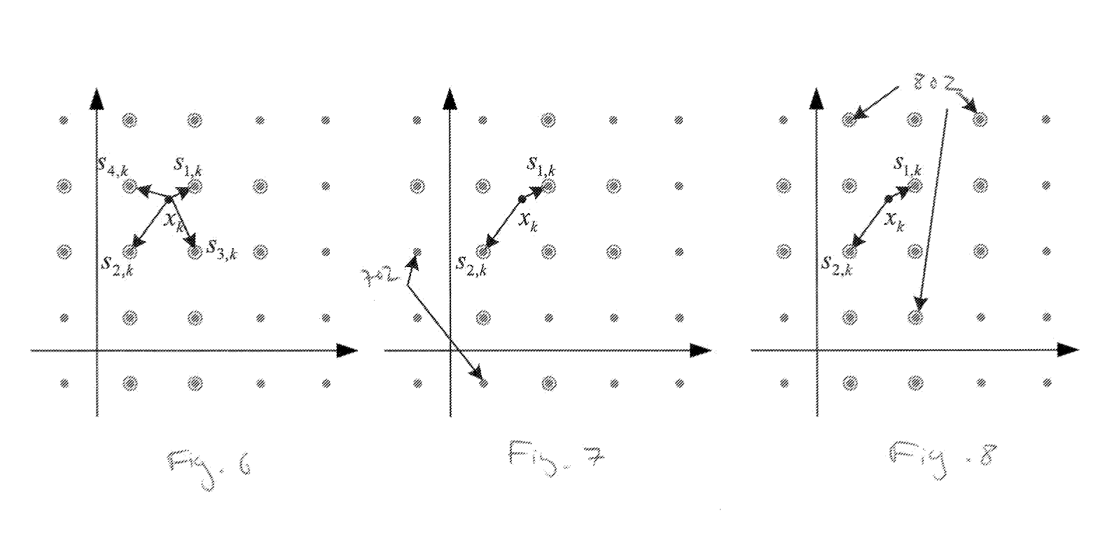

In other embodiments, any other suitable set St of constellation points may be selected with respect to the value xₖ. For example, the initial constellation points may include more than two constellation points, e.g., four initial constellation points, denoted s_{1,k}, s_{2,k}, s_{3,k}, and s_{4,k}, as shown in FIG. 6. The initial constellation points may include any combination of the points s_{1,k}, s_{2,k}, s_{3,k}, and s_{4,k}. For example, the initial constellation points may include the set {s_{1,k},s_{3,k}} or the set {s_{1,k},s_{2,k},s_{3,k}}, e.g., when only two initial constellation points are used; the set {s_{1,k},s_{2,k}, s_{3,k}}, e.g., when three initial constellation points are used. In one embodiment, the initial constellation points may be selected adaptively, e.g., according to their metrics. Additionally or alternatively, the set St may be defined to include only some of the constellation points according to Equations 6 and/or 7, for example, excluding one or more constellation points 702, e.g., to reduce complexity, as shown in FIG. 7. Additionally or alternatively, the set St may be defined to include one or more additional points 802 in addition to the constellation points according to Equations 6 and/or 7, e.g., to increase performance, as shown in FIG. 8. The additional points added to the set St and/or the points eliminated from the set St may be selected, for example, based the distance of the points from value xₖ and/or LLR generation requirements.

In some demonstrative embodiments, MIMO decoder 116 may decode the MIMO transmission using the plurality of sets of selected constellation points St, e.g., using any suitable decoding process and/or algorithm.

In some demonstrative embodiments, decoder 116 may decode the MIMO transmission by applying a suitable “enhanced fast (EF) MLD” decoding algorithm having a complexity of N_{TX}×R, e.g., as described below.

In some embodiments, the decoding algorithm may include scanning each of the N_{Tx} streams. For each stream the set St may be determined, e.g., as described herein; the contribution of each constellation point of the set St may be subtracted from the received MIMO transmission; and a linear decoding method, e.g., ZF or MMSE, may be applied to decode the remaining N_{Tx}−1 streams. Accordingly, a set of R hypotheses may be determined for each stream. Accordingly, a set of N_{Tx}×R hypotheses may be determined, e.g., after scanning over all the N_{Tx} streams. Decoder 116 may then decode the MIMO transmission by selecting a hypothesis of the set of hypotheses, for example, using a suitable decision making algorithm, e.g., a suitable hard-decision or soft-decision algorithm.

In some demonstrative embodiments, for each i-th stream, denoted sᵢ, of the N_{Tx} streams, i=0 . . . N_{Tx}−1, Equation 1 may be rewritten as follows:

y=hᵢsᵢ+Hᵣsᵣ+n (8)

wherein hᵢ denotes an i-th column of the matrix H; wherein Hᵣ denotes the remaining columns of matrix H, excluding the column hᵢ; and wherein sᵣ denotes the remaining N_{Tx}−1 streams, excluding the stream sᵢ.

In some demonstrative embodiments, for each i-th stream, the value of sᵢ may be scanned over each signal hypothesis, denoted aₖ, k=1 . . . R, of to the set St of constellation points corresponding to the i-th stream. The remaining contribution, denoted z_{i,k}, of the remaining sᵣ streams to the received signal may be determined by subtracting from the received signal the associated contribution of the signal hypothesis aₖ, e.g., as follows:

z_{i,k}=y−hᵢaₖ=Hᵣsᵣ+nₖ (9)

wherein nₖ denotes the noise associated with the remaining contribution z_{i,k}.

In some demonstrative embodiments, a linear decoding method may be applied to Equation 8, to determine the linear solution, denoted ŝ_{r,k}, corresponding to the remaining streams. For example, the linear solution s_{i,k} may be determined by applying the MMSE algorithm, e.g., as follows:

ŝ_{r,k}=(Hᵣ^{H}Hᵣ+σ²I)⁻¹Hᵣ^{H}z_{i,k} (10)

In some demonstrative embodiments, a k-th hypotheses, denoted s_{i,k}, of the transmitted signal may be determined based on Equation 10, e.g., as follows:

s_{i,k}=[slice(ŝ_{r,k}),sᵢ=aₖ] (11)

In some demonstrative embodiments, a set of hypotheses, Z={s_{i,k}}, may be determined for each k=1 . . . R and for each i-th stream, e.g., based on Equation 11.

In some demonstrative embodiments, a square distance, denoted d_{i,k}², between each hypothesis of the set Z and the received signal y may be determined, e.g., as follows:

d_{i,k}²=∥y−Hs_{i,k}∥² (12)

In some demonstrative embodiments, a hard-decision estimate, denoted ŝ, of the symbol s may be determined, e.g., as follows:

ŝ=Arg min_{k,i}(d_{i,k}²) (13)

In some demonstrative embodiments, an LLR metric, denoted LLRᵢ(m), corresponding to an m-th bit, m=0 . . . (log Q−1), of the i-th stream may be determined, e.g., as follows:

LLRᵢ(m)=min_{sεZ}_{_{i,m}}_{⁺}d²(s)−min_{sεZ}_{_{i,m}}_{^{−}}d²(s) (14)

wherein Z_{i,m}⁺ denotes a symbol vector set, in which the m-th bit in the i-th stream is set to one; and wherein Z_{i,m}⁻ denotes a symbol vector set, in which the m-th bit in the i-th stream is set to zero.

In other embodiments, decoder 116 may decode the MIMO transmission by applying any other suitable decoding algorithm having any other suitable complexity. In one example, decoder 116 may decode the MIMO transmission by applying the decoding algorithm described by Y. Lomnitz et al.: “Efficient maximum likelihood detector for MIMO systems with small number of streams”, Electronics Letters, Volume 43, Issue 22, Oct. 25 2007, while using only the sets St of R constellation points, e.g., instead of the Q constellation points.

In some demonstrative embodiments, decoder 116 may decode the MIMO transmission by separating the received signal y into the real and imaginary components, denoted yᵣ and yᵢ, respectively. According to these embodiments, the received signal y may be represented by the following vector, denoted y_{c}:

$${y}_{c} = {[ {y}_{r}^{T} {y}_{i}^{T} ]}^{T} = \underbrace{[ \begin{matrix}{H}_{r} & - {H}_{i} \\ {H}_{i} & {H}_{r}\end{matrix} ]}_{{H}_{c}} \underbrace{[ \begin{matrix}{S}_{r} \\ {S}_{i}\end{matrix} ]}_{{S}_{c}} + \underbrace{[ \begin{matrix}{n}_{r} \\ {n}_{i}\end{matrix} ]}_{{n}_{c}} \qquad ( 15 )$$

wherein Hᵣ, Hᵢ, sᵣ, sᵢ, nᵣ, and nᵢ, denote the real and imaginary components of H, s, and n, respectively; and wherein H_{c} is a 2N_{Rx}×2N_{Tx} real valued matrix, s_{c} is a 2N_{Tx}×1 \sqrt{Q}−PAM constellation vector and n_{c} is white noise if n is white noise.

According to these embodiments, decoder 116 may perform the EF MLD decoding algorithm described above, while searching over 2N_{Tx} streams, each mapped over a \sqrt{Q}−PAM constellation scheme. Accordingly, the set of hypothesis may include 2 N_{Tx}*sqrt(Q) hypotheses. In addition, all manipulations and/or calculations are performed on real numbers, rather than complex numbers.

In some demonstrative embodiments, the set St may be defined with respect to a single initial constellation point, e.g., the constellation point s₁. For example, the set St may include all constellation points on the same column as the initial constellation point and all constellation points on the same row of the initial constellation point. The complex representation of Equation 1 may be solved by setting the imaginary component of the symbol to an imaginary component of a linear solution of Equation 1, while testing the hypotheses with regards to the real components of the set St; and setting the component of the symbol to a real component of a linear solution of Equation 1, while testing the hypotheses with regards to the imaginary components of the set St. According to these embodiments, decoder 116 may determine the set of hypotheses by separating the set St into the real and imaginary components; determining a first set of hypotheses including the real components of the set St, while setting the imaginary component of the hypothesis to include the linear solution for the imaginary component, e.g., according to the MMSE or ZF solutions, and the like; and determining a second set of hypotheses including the imaginary components of the set St, while setting the real component of the hypothesis to include the linear solution for the real component, e.g., according to the MMSE or ZF solutions, and the like.

In some demonstrative embodiments, decoder 116 may scan each of the NTx streams individually for determining the set of hypotheses, e.g., as described above. However in other embodiments, decoder 116 may combine two or more of the streams for determining the set of hypotheses.

In some demonstrative embodiments, the same number of initial points and/or the same number R of constellation points may be used for each of the streams. In other embodiments, different numbers of initial points and/or different numbers R of constellation points may be used for each of the streams, e.g., to reduce complexity.

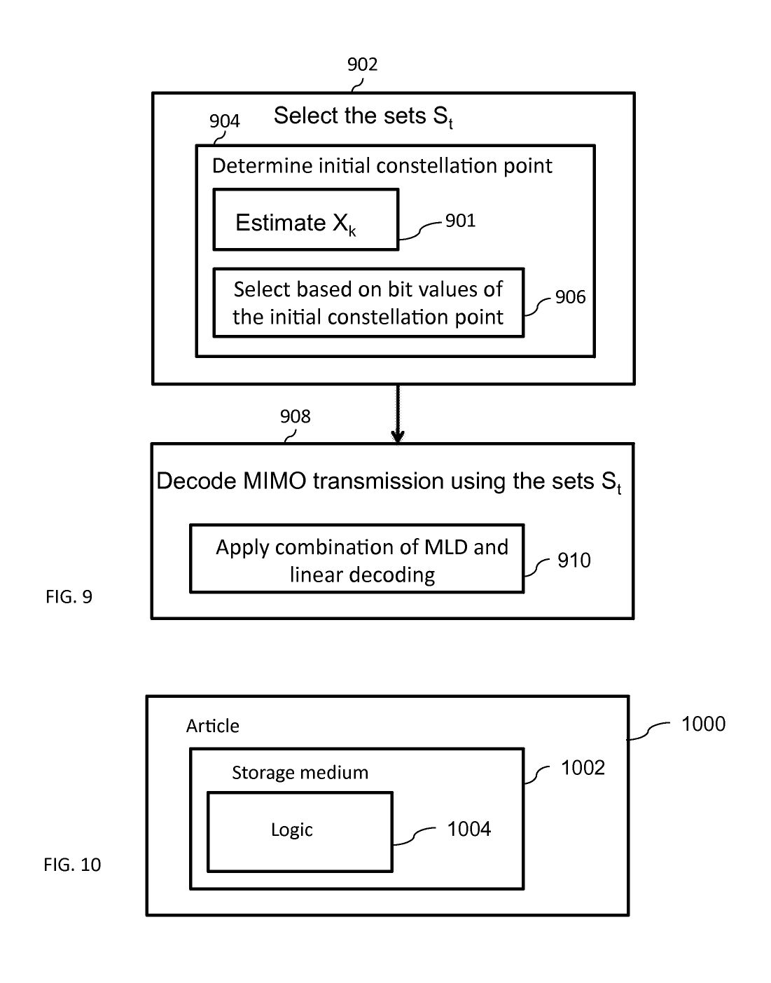

Reference is mad to FIG. 9, which schematically illustrates a method of decoding a MIMO transmission, in accordance with some demonstrative embodiments. In some embodiments, one or more operations of the method of FIG. 9 may be performed by a device, e.g., device 112 (FIG. 1), a receiver, e.g., receiver 114 (FIG. 1) and/or a decoder, e.g., decoder 116 (FIG. 1) to decode a plurality of streams of a MIMO transmission encoded over a constellation plane including a first number of constellation points.

As indicated at block 902, the method may include selecting a plurality of sets of selected constellation points corresponding to a plurality of received values of at least one stream of the streams. For example, decoder 116 (FIG. 1) may select the sets St, e.g., as described above.

As indicated at block 904, selecting the sets my include determining, for each received value of the stream, at least one initial constellation point. For example, decoder 116 (FIG. 1) may determine at least one initial constellation point s₁, e.g., as described above.

As indicated at block 901, the method may include estimating a transmitted value corresponding to the received value and determining the initial constellation point based on the estimated value. For example, decoder 116 (FIG. 1) may determine constellation point s₁ based on the value of xₖ, e.g., as described above.

As indicated at block 906, selecting the plurality of sets may include selecting a set of selected constellation points including the initial constellation point, wherein the selected set of constellation points includes a second number, lesser than the first number, of the constellation points, such that, for each bit-location of the initial constellation point, the selected set of constellation points includes at least one constellation point having, at the bit location, a bit value opposite to the bit value of the initial constellation point at the bit location. For example, decoder 116 (FIG. 1) may determine the set St, according to Equation 6 or 7, e.g., as described above.

As indicated at block 908, the method may include decoding the MIMO transmission using the plurality of sets of selected constellation points.

As indicated at block 910, decoding the MIMO transmission may include applying a maximum likelihood detection method to the selected constellation points corresponding to the values of the at least one stream, and applying a linear decoding method to one or more other streams. For example, decoder 116 (FIG. 1) may decode the MIMO transmission by applying the EF MLD decoding algorithm to the plurality of sets of constellation points, e.g., as described above.

Reference is made to FIG. 10, which schematically illustrates an article of manufacture 10, in accordance with some demonstrative embodiments. Article 1000 may include a machine-readable storage medium 1002 to store logic 1004, which may be used, for example, to perform at least part of the functionality of wireless communication unit 104 (FIG. 1), wireless communication device 102 (FIG. 1), wireless communication unit 132 (FIG. 1), wireless communication device 130 (FIG. 1); and/or to perform one or more operations of the method of FIG. 6.

In some demonstrative embodiments, article 1000 and/or machine-readable storage medium 1002 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A device including:
a multiple-input-multiple-output (MIMO) decoder to decode a MIMO transmission encoded over a constellation scheme including a first number of constellation points; wherein, the decoder is to determine at least one initial constellation point corresponding to at least one received value of the MIMO transmission, and to select a set of selected constellation points including the initial constellation point, wherein the selected set of constellation points includes a second number, lesser than the first number, of the constellation points, and wherein, for each bit-location of the initial constellation point, the selected set of constellation points includes at least one constellation point having, at the bit location, a bit value opposite to the bit value of the initial constellation point at the bit location; and wherein the decoder is to decode the MIMO transmission using the set of selected constellation points.

2. The device of claim 1, wherein the decoder is to decode the MIMO transmission by applying a maximum likelihood detection method to the selected constellation points corresponding to the values of at least one stream of the MIMO transmission, and to apply a linear decoding method to one or more other streams of the MIMO transmission.

3. The device of claim 1, wherein, for each bit-location of the initial constellation point, the selected set of constellation points includes a single constellation point at a shortest distance from the initial constellation point with respect to other constellation points having, at the bit location, a bit value opposite to the bit value of the initial constellation point at the bit location.

4. The device of claim 1, wherein the decoder is to select at least first and second initial constellation points for the received value, and to select the set of selected constellation points based on the first and second initial constellation points.

5. The device of claim 1, wherein the decoder is to estimate a transmitted value corresponding to the received value and to determine the initial constellation point based on the estimated value.

6. The device of claim 1, wherein the second number of constellation points includes less than half of the first number of constellation points.

7. The device of claim 1, wherein the first number of constellation points includes at least sixty-four constellation points.

8. A method of decoding a plurality of streams of a multiple-input-multiple-output (MIMO) transmission encoded over a constellation scheme including a first number of constellation points, the method including:
selecting a plurality of sets of selected constellation points corresponding to a plurality of received values of at least one stream of the streams by determining, for at least one received value of the stream, at least one initial constellation point, and selecting a set of selected constellation points including the initial constellation point, wherein the selected set of constellation points includes a second number, lesser than the first number, of the constellation points, such that, for each bit-location of the initial constellation point, the selected set of constellation points includes at least one constellation point having, at the bit location, a bit value opposite to the bit value of the initial constellation point at the bit location; and
decoding the MIMO transmission using the plurality of sets of selected constellation points.

9. The method of claim 8, wherein decoding the MIMO transmission includes applying a maximum likelihood detection method to the selected constellation points corresponding to the values of the at least one stream, and applying a linear decoding method to one or more other streams.

10. The method of claim 8, wherein, for each bit-location of the initial constellation point, the selected set of constellation points includes a single constellation point at a shortest distance from the initial constellation point with respect to other constellation points having, at the bit location, a bit value opposite to the bit value of the initial constellation point at the bit location.

11. The method of claim 8, wherein determining the at least one initial constellation point includes selecting at least first and second initial constellation points for each received value, and wherein selecting the set of constellation points includes selecting the set of constellation points based on the first and second initial constellation points.

12. The method of claim 8 including estimating a transmitted value corresponding to the received value and determining the initial constellation point based on the estimated value.

13. The method of claim 8, wherein the second number of constellation points includes less than half of the first number of constellation points.

14. The method of claim 8, wherein the first number of constellation points includes at least sixty-four constellation points.

15. A wireless communication system including:
a wireless communication device including:
a plurality of antennas to receive a respective plurality of streams of a multiple-input-multiple-output (MIMO) transmission encoded over a constellation scheme including a first number of constellation points; and
a decoder to determine at least one initial constellation point corresponding to at least one received value of the MIMO transmission, and to select a set of selected constellation points including the initial constellation point, wherein the selected set of constellation points includes a second number, lesser than the first number, of the constellation points, and wherein, for each bit-location of the initial constellation point, the selected set of constellation points includes at least one constellation point having, at the bit location, a bit value opposite to the bit value of the initial constellation point at the bit location; and wherein the decoder is to decode the MIMO transmission using the set of selected constellation points.

16. The system of claim 15, wherein the decoder is to decode the MIMO transmission by applying a maximum likelihood detection method to the selected constellation points corresponding to the values of the at least one stream of the MIMO transmission, and to apply a linear decoding method to one or more other streams.

17. The system of claim 15, wherein, for each bit-location of the initial constellation point, the selected set of constellation points includes a single constellation point at a shortest distance from the initial constellation point with respect to other constellation points having, at the bit location, a bit value opposite to the bit value of the initial constellation point at the bit location.

18. The system of claim 15, wherein the decoder is to select at least first and second initial constellation points for the received value, and to select the set of selected constellation points based on the first and second initial constellation points.

19. The system of claim 15, wherein the decoder is to estimate a transmitted value corresponding to the received value and to determine the initial constellation point based on the estimated value.

20. The system of claim 15, wherein the second number of constellation points includes less than half of the first number of constellation points.
